(19) United States
(12) Patent Application Publication
(10) Pub. No.: US 2013/0003975 A1
(43) Pub. Date: Jan. 3, 2013

(54) COMMUNICATION APPARATUS AND METHOD AND COMMUNICATION SYSTEM

(75) Inventors: Isamu FUKUDA, Yokohama (JP); Atsushi MOROHASHI, Setagaya (JP)

(73) Assignee: FUJITSU LIMITED, Kawasaki-shi (JP)

(21) Appl. No.: 13/609,492

(22) Filed: Sep. 11, 2012

Related U.S. Application Data
(63) Continuation of application No. PCT/JP2010/054570, filed on Mar. 17, 2010.

(51) Int. Cl. H04L 9/00

(52) U.S. Cl. 380/273

(57) ABSTRACT

A communication apparatus that performs encrypted communication of data to an opposing apparatus, the communication apparatus comprising, a communication unit which uses an encryption key to perform encrypted communication of the data, a rekey unit which updates the encryption key; and a control unit which, after it is confirmed that communication using the encryption key after updating has been enabled, starts encrypted communication of the data using the encryption key after updating.

### CROSS-REFERENCE TO RELATED APPLICATIONS

This application is a continuation application based on International application No. PCT/JP2010/054570, filed on Mar. 17, 2010, the entire contents of which are incorporated herein by reference.

### FIELD

The embodiments discussed herein are related to a communication apparatus and method and a communication system for performing encrypted communication based, for example, on IPsec standard. For example, to a technical field of communication apparatus and method and communication system for performing encrypted communication in which encryption key is appropriately updated.

### BACKGROUND

As such encrypted communication, a technology using a protocol known as IPsec (Security architecture for Internet Protocol) has been known. IPsec is a protocol which uses encryption technology to provide functions that enable prevention of falsification or concealment in units of IP packets. IPsec is standardized, and is sometimes called as IPsec standard. As a transmission method in packet communication based on IPsec standard, a technology called SA (Security Association) is known in which information such as encryption scheme and encryption key is shared between a transmission apparatus and a reception apparatus before starting communication, so that an IP tunnel is established as a virtual encrypted communication channel and secure communication is performed.

In IPsec standard, rekey processing is indispensable and is executed periodically in regular and/or irregular manner. Various procedures for rekeying in encrypted communication such as IPsec communication are discussed in related art.

Related art is disclosed in Japanese Laid-open Patent Publications No. 2009-65528, 2009-65625 and 2008-109404.

### SUMMARY

According to an aspect of the embodiment, a communication apparatus for executing encrypted communication of data with an opposing apparatus is provided. The communication apparatus comprises a communication unit which uses an encryption key to perform encrypted communication of the data, a rekey unit which updates the encryption key, and a control unit which, after it is confirmed that communication using the encryption key after updating has been enabled, starts encrypted communication of the data using the encryption key after updating.

According to an aspect of the embodiment, a communication method is provided. The communication method comprises performing encrypted communication of the data using an encryption key, updating the encryption key, and starting encrypted communication of the data using the encryption key after updating controlling, after it is confirmed that communication using the encryption key after updating has been enabled.

According to an aspect of the embodiment, a communication system which performs encrypted communication of data between a communication apparatus and an opposing apparatus is provided. At least one of the communication apparatus and the opposing apparatus comprises a communication unit which uses an encryption key to perform encrypted communication of the data, a rekey unit which updates the encryption key, and a control unit which, after it is confirmed that communication using the encryption key after updating has been enabled, starts encrypted communication of the data using the encryption key after updating.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of the construction of IPsec network;

FIG. 2 is a view depicting an exemplary construction of a LTE wireless network;

FIG. 3 is a view depicting an exemplary sequence of updating the encryption key in IPsec communication;

FIG. 4 is a block diagram depicting an exemplary construction of the communication apparatus according to a first embodiment;

FIG. 5 is a view depicting an exemplary sequence of updating the encryption key in the first embodiment;

FIG. 6 is a view depicting an exemplary sequence of updating the encryption key in the first embodiment;

FIG. 7 is a view depicting an exemplary protocol stack in the first embodiment;

FIG. 8 is a view depicting an exemplary protocol stack in the first embodiment;

FIG. 9 is a view depicting an exemplary sequence of updating an encryption key in the communication apparatus in the second embodiment;

FIG. 10 is a view depicting an exemplary protocol stack in the second embodiment; and

FIG. 11 is a view depicting an exemplary sequence of updating an encryption key in the third embodiment.

### DESCRIPTION OF EMBODIMENTS

### (1) Introduction

(1-1) IPsec Communication

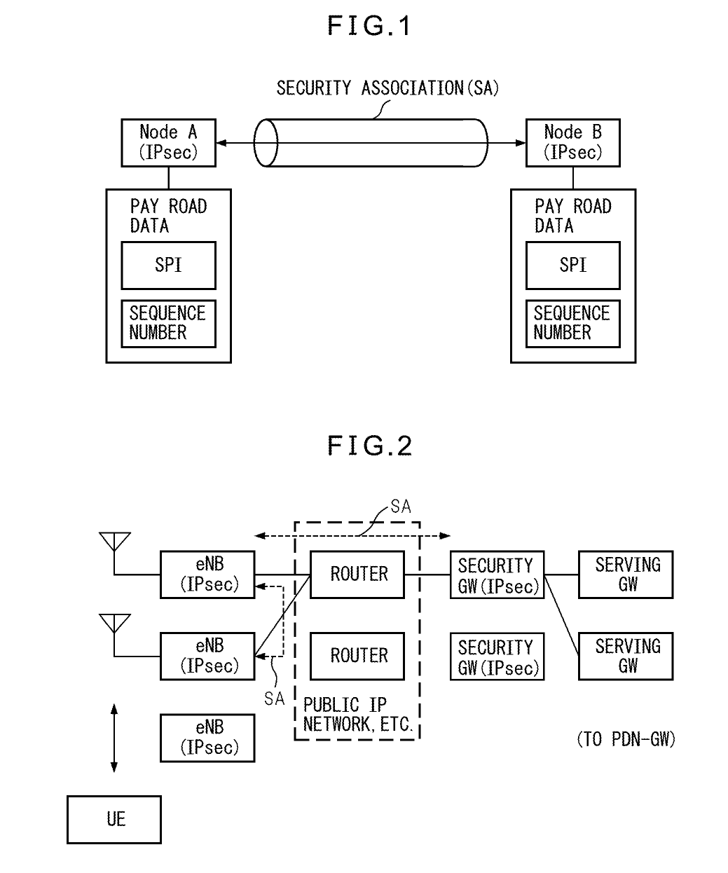

Now, referring to FIGS. 1 and 2, SA using an encryption key in IPsec communication will be described. FIG. 1 is a schematic view depicting a state in which encrypted communication is performed between a communication apparatus NodeA and a communication apparatus NodeB with SA provided as an IP tunnel using IPsec.

As depicted in FIG. 1, a packet transmitted from the communication apparatus NodeA is transmitted to the communication apparatus NodeB via SA provided between the communication apparatus NodeA and the communication apparatus NodeB. Here, the encryption key for using SA is appropriately updated by Rekey processing, and new SA in accordance with the encryption key after updating is successively used. Examples of such communication apparatus NodeA and communication apparatus NodeB include, for example, a radio base station, a security GW (Gate Way), and the like.

The communication apparatus NodeA and the communication apparatus NodeB having SA provided as depicted in FIG. 1, include SPI (Security Parameter Index), Sequence Number, etc., as payload data. SPI is an identification number for identifying SA, which is information that enables identification of old and new SA before and after updating the encryption key. The sequence number is an identification number for identifying data packet transmitted using SA.

IPsec communication technology is used, for example, in a radio network system such as LTE (Long Term Evolution) as depicted in FIG. 2. FIG. 2 is a block diagram depicting an exemplary construction of a LTE radio network. The LTE radio network comprises a radio base station apparatus eNB (eNodeB: evolved NodeB), a router, a security GW, and a serving GW. The radio base station apparatus eNB performs transmission and reception of user packets to and from mobile terminals (UE: User Equipment) via an antenna.

In LTE radio network, a public IP network, for example, may be used between a radio base station apparatus eNB and an opposing apparatus such as a serving GW or a MME (Mobility Managing Entity). Therefore, in order to establish secure communication, IPsec communication is preferably used. In the example of FIG. 2, IPsec SA is provided between a radio base station eNB and a serving GW, or between two radio base stations eNB (see dotted line). In the example of FIG. 2, IPsec encrypts the packet signal between a radio base station eNB and a serving GW, or between two radio base stations eNB.

(1-2) Exemplary Rekey Processing Sequence

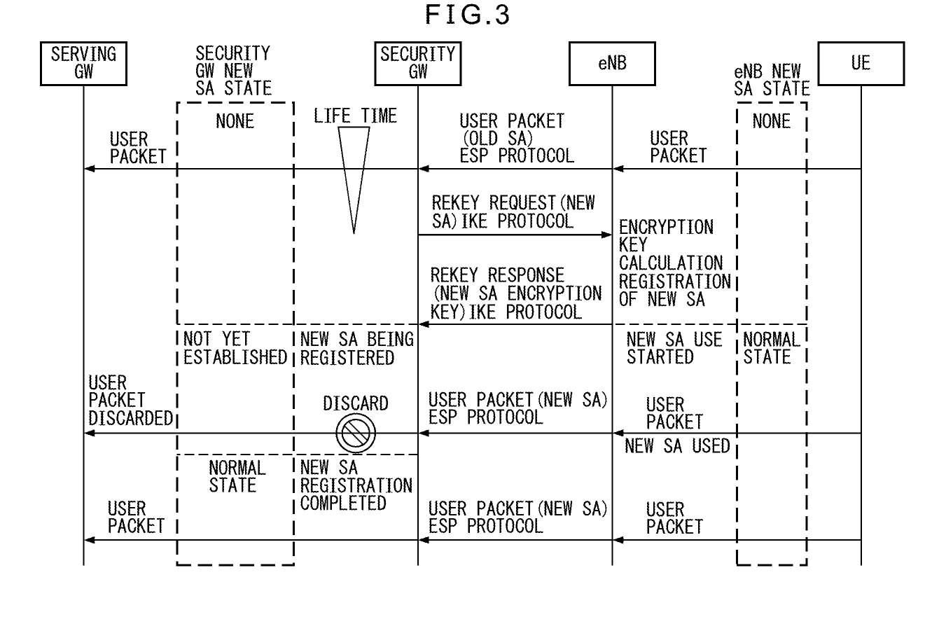

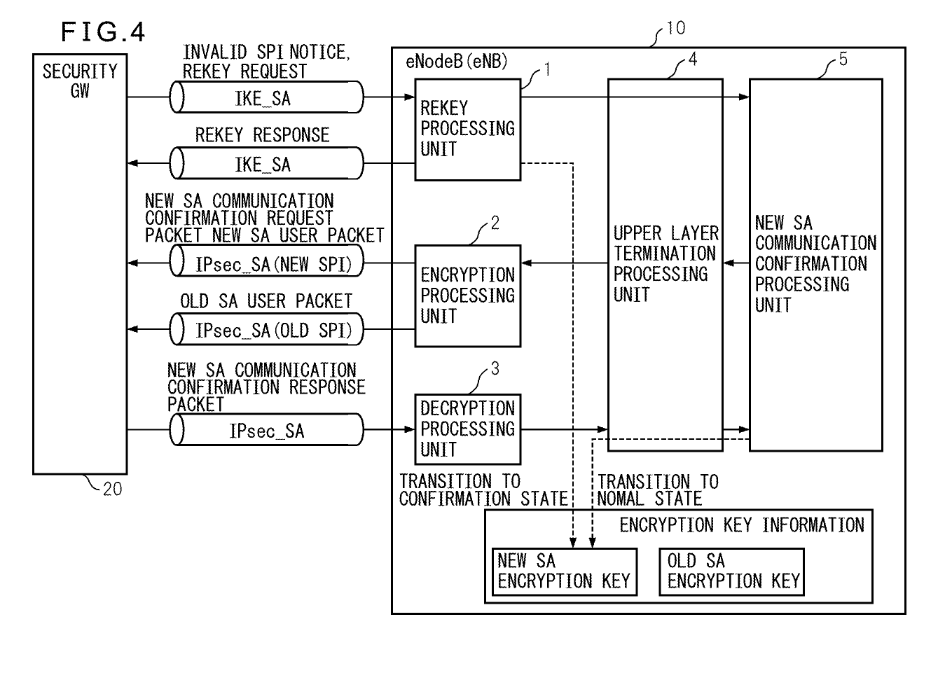

Referring to FIG. 3, an exemplary rekey processing sequence will be described below. FIG. 3 is a view depicting an example of processing sequence of each unit in the rekey processing.

In a communication system, a user packet is first transmitted from a UE to a eNB. The eNB encrypts the user packet using old SA before updating, and transmits it to a security GW on the receiver side in IPsec communication through ESP (Encapsulating Security Payload) protocol. The security GW transmits the received user packet to a serving GW as an opposing apparatus.

Next, when lifetime of an old SA before updating expires, a security GW transmits a rekey request to the eNB using IKE (Internet Key Exchange) protocol. In response to the rekey request, the eNB carries out calculation of an encryption key and performs registration processing of new SA.

When registration processing of the new SA is completed in the eNB, new SA can be used in the eNB. At this time, the eNB transmits information on the new encryption key as rekey response to the security GW using IKE protocol. Upon receiving the transmitted encryption key after updating, the security GW performs registration processing of the new SA. While the registration processing of the new SA is being performed in the security GW, the new SA is not yet established in the security GW.

At this time, if the eNB transmits a user packet using the new SA, the user packet is discarded since the new SA cannot yet be used in the security GW. Then, the discarded packet is not transmitted to the serving GW. The discarded packet may be appropriately retransmitted by upper layer.

When a certain time has elapsed after the start of registration processing, registration of the new SA is completed in the security GW, and the new SA is enabled. At this time, if the eNB transmits a user packet using the new SA, the user packet is properly received in the security GW, and is transmitted to the serving GW.

In accordance with the exemplary sequence described above, there is a technical problem that, every time encryption key is updated, some user packets are discarded, leading to degradation of the network quality. Although discarded packet can be retransmitted for restoration by the upper layer, traffic may be increased transiently. Therefore, in the present embodiment, a method as described below is applied to resolve this technical problem.

### (2) First Embodiment

Now, a first embodiment will be described below with reference to drawings.

(2-1) Exemplary Basic Construction

Referring to FIG. 4, the construction of eNB (Evolved NodeB: radio base station apparatus) 10 as a communication apparatus according to an embodiment, and rekey processing of the encryption key in IPsec communication between the eNB and a security GW 20 as an example of opposing apparatus will be described. As depicted in FIG. 4, eNB 10 comprises a rekey processing unit 1, an encryption processing unit 2, a decryption processing unit 3, a upper layer termination processing unit 4 and a new SA communication confirmation processing unit 5.

The rekey processing unit 1 is an example of the rekey unit according to the embodiment, and receives SA rekey request from the security GW 20, and executes rekey processing. When the rekey processing is completed, it also transmits information on the encryption key after updating as rekey response to the security GW 20. At this time, the rekey processing unit 1 changes the state of the new SA encryption key stored in the information on the encryption key to the confirmed state. The rekey processing unit 1 is a IKE protocol terminal and performs communication with the security GW using IKE protocol.

The encryption processing unit 2 is an example constituting a part of communication unit of the embodiment, and retrieves SA encryption key corresponding to the packet to be encrypted to perform encryption processing. It transmits the encrypted user packet to an external security GW 20 or the like. The encryption processing unit 2 of the present embodiment encrypts a new SA communication confirmation request signal transmitted from the upper layer termination processing unit 4 and transmits it to the security GW 20.

The decryption processing unit 3 is an example constituting a part of the communication unit according to the embodiment, and retrieves SA decryption key corresponding to the packet to be decrypted, and performs decryption processing. It also decrypts an encrypted user packet transmitted from the security GW 20, and transmits it to the upper layer termination processing unit 4. Also, the decryption processing unit 3 of the present embodiment decrypts new SA communication confirmation response signal transmitted from the security GW 20, and transmits it to the upper layer termination processing unit 4.

The upper layer termination processing unit 4 is a termination of upper layers such as GTP-U (GPRS Tunneling Protocol-User plane), ICMP (Internet Control Message Protocol), etc. In response to a request of the new SA communication confirmation processing unit 5, the upper layer termination processing unit 4 transmits a request for new SA communication confirmation to the encryption processing unit 2, and receives the new SA communication confirmation response packet from the security GW 20 received by the decryption processing unit 3.

The new SA communication confirmation processing unit 5 is an example of the control unit of the embodiment, and detects the rekey response processing in the rekey processing unit 1, and asks the upper layer termination processing unit 4 to transmit a new SA communication confirmation request. It also receives a new SA communication confirmation response from the security GW 20, and changes the state of the new SA encryption key stored in the encryption key information to the normal state indicating that the new encryption key is enabled.

If SA used in the encrypted user packet transmitted from the encryption processing unit is not enabled in the security GW 20, the security GW 20 transmits invalid SPI notice indicating an invalid SPI to the rekey processing unit 1.

Although detailed construction of the security GW 20 is omitted in FIG. 4, the security GW 20 has typically the same construction as eNB 10.

(2-2) Exemplary First Rekey Processing Sequence

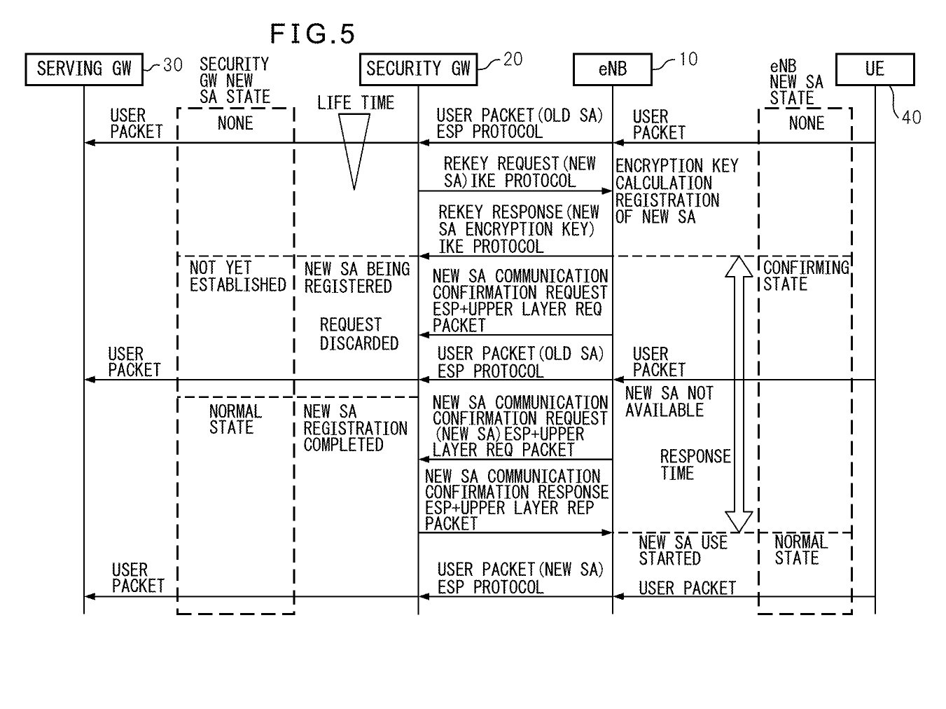

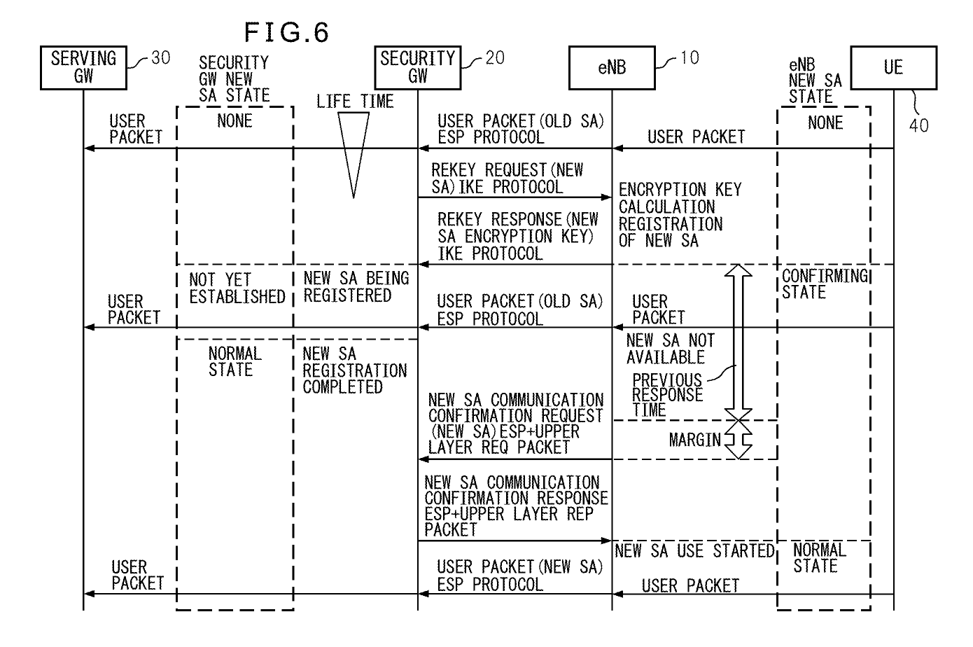

First time rekey processing of the encryption key performed in the communication apparatus according to the present embodiment will be described below with reference to FIG. 5. FIG. 5 is a view that depicts processing sequence of each unit in the first time rekey processing of the encryption key. The first time rekey processing of the encryption key means that rekey processing of the encryption key is performed in a state where no response time information from transmission of the encryption key after updating until the new SA communication confirmation has not been accumulated in the previous rekey processing.

In the communication system using eNB 10 of the present embodiment, a user packet is transmitted from UE 40 to eNB 10. The encryption processing unit 2 of eNB 10 encrypts the user packet using old SA before updating, and transmits it to the security GW 20 on the reception side of IPsec communication through ESP protocol. The security GW 20 transmits the received user packet to the serving GW 30 as the opposing apparatus.

Next, if the lifetime of the old SA before updating has expired, the security GW 20 sends rekey request to eNB 10 using IKE protocol. In response to the rekey request, the rekey processing unit 1 of eNB 10 performs calculation of the encryption key, and registers the new SA.

After the rekey processing unit 1 of eNB 10 has completed registration processing of the new SA, the rekey processing unit 1 of eNB 10 transmits information on new encryption key in rekey response to the security GW 20 using IKE protocol, and switches the state of new SA to the confirmed state. Upon receiving the transmitted encryption key after updating, the security GW 20 performs registration processing of the new SA. While the registration processing of the new SA is being performed in the security GW 20, the new SA is not yet established in the security GW.

While new SA is being registered in the security GW 20, the encryption processing unit 2 transmits the user packet to the security GW 20 using old SA before updating. In the security GW 20 while in new SA registration processing, the new SA is not yet enabled, and communication of user packets can be performed only by using old SA.

The new SA communication confirmation processing unit 5 of eNB 10 transmits confirmation request for communication of new SA to the security GW 20 using new SA. New SA communication confirmation request is transmitted, for example, by ESP protocol and through REQ packet of upper layer. At this time, in practice, the new SA communication confirmation processing unit 5 asks the upper layer termination processing unit 4 to generate new SA communication confirmation request, and transmits the new SA communication confirmation request signal to the security GW 20 in the encryption processing unit. Hereinafter, it is described that the new SA communication confirmation processing unit 5 transmits the request signal, omitting a series of processing described above.

While the security GW 20 that received new SA communication confirmation request is registering the new SA, the new SA is not yet authenticated and cannot be used, so that the new SA communication confirmation request is discarded.

The new SA communication confirmation processing unit 5 of eNB 10 performs processing of transmitting the new SA communication confirmation request plural times at a certain period. The period of this transmission is set such that it does not affect increase of traffic and degradation of security in the communication system.

When a certain time has elapsed after the start of registration processing, registration of the new SA is completed in the security GW 20, and the new SA is enabled. After new SA is enabled, if the new SA communication confirmation request is received from eNB 10, the security GW 20 transmits new SA communication confirmation response to eNB 10 by ESP protocol and through REP packet of upper layer. The rekey processing unit 1 of eNB 10 switches the state of the new SA to normal state after receiving the new SA communication confirmation response, and thereafter, the encryption processing unit 2 starts transmission of user packets using the new SA.

The new SA communication confirmation processing unit 5 of eNB 10 of the present embodiment, after receiving the new SA communication confirmation response, counts the time from transmission of the new encryption key information as rekey response to the security GW 20 until reception of the new SA communication confirmation response, and stores it as response time information in the internal memory.

(2-3) Exemplary Rekey Processing Sequence after the First Time

Rekey processing of encryption key after the first time by the communication apparatus according to the present embodiment will be described below with reference to FIG. 6. FIG. 6 is a view depicting the processing sequence of each unit in the rekey processing after the first time. The rekey processing after the first time means the rekey processing of the encryption key in a state where response time information from transmission of new encryption key information until confirmation of new SA communication in the previous rekey processing of the encryption key is stored in the internal memory of eNB 10. In the rekey processing after the first time, same processing as in the first time rekey processing may be performed except the parts to be described below, so that description of the same processing will be omitted.

In the rekey processing sequence after the first time, after transmission of new encryption key information to the security GW 20, instead of transmission of new SA communication confirmation request at a certain period, the new SA communication confirmation processing unit 5 determines the timing of transmission of new SA communication confirmation request based on the response time information from the transmission of new encryption key until the new SA communication confirmation in previous processing stored in the memory. Specifically, the new SA communication confirmation processing unit 5 of eNB 10 reads out the response time information in the previous processing from the memory. And the new SA communication confirmation processing unit 5 transmits the new SA communication confirmation request to the security GW 20 when, after the rekey processing unit 1 transmits the new encryption key information, the response time with a certain margin added thereto has elapsed.

In the rekey processing sequence after the first time, the response time information stored in the memory has actual experience as the time used for registering the new SA in the previous updating of the encryption key. Therefore, by transmitting the new SA communication confirmation request based on this response time, eNB 10 can transmit the communication confirmation request at a time when the new SA is estimated to have communicated without need to transmit the communication confirmation request plural times. In particular, since the new SA communication confirmation processing unit 5 of eNB 10 of the present embodiment determines the timing for transmitting the new SA communication confirmation request based on the time information indicated by the response time information with a certain margin added thereto, the new SA communication confirmation request can be transmitted more appropriately after the communication of the new SA. This margin may be appropriately determined using some method based on the response time information, or the margin may be such that the margin=0.

With the construction as described above, in the rekey processing sequence after the first time, the new SA communication confirmation can be performed in proper timing, so that increase of traffic and processing load due to transmission in plural times of new SA communication confirmation request can be prevented. In the rekey processing sequence after the first time, the encryption processing unit 2 of eNB 10 may, after the response time plus a certain time margin has elapsed, instead of transmitting new SA communication confirmation request, switch the state of the new SA to normal state, and start transmission of user packets using the new SA. With such construction, increase of traffic due to transmission of new SA communication confirmation request can be further suppressed, and encrypted communication using new SA can be started sooner, leading to improved security.

IP protocol is used in the new SA communication confirmation request and the new SA communication confirmation response according to the present embodiment. For such new SA communication confirmation, GTP-U echo signal, for example, may be used, and in this case, the encryption processing unit 2 of eNB 10 transmits GTP-U Echo Request signal as the new SA communication confirmation request to the security GW 20. The security GW 20 transmits GTP-U Echo Reply signal as the new SA communication confirmation response to eNB 10. However, in the present embodiment, any other signal may be used for the new SA communication confirmation.

For example, the encryption processing unit 2 of eNB 10 may, instead of using GTP-U Echo Request/Reply signal, use GTP-U Error Indication signal for the new SA communication confirmation. Specifically, the encryption processing unit 2 of eNB 10 may use unregistered tunnel endpoint identifier (TEID: Tunnel Endpoint Identifier) in the new SA communication confirmation request packet to transmit to the security GW 20. At this time, if the new SA is enabled in the security GW 20, the security GW 20 uses same TEID as GTP-U Error Indication to transmit to eNB 10. The encryption processing unit 2 uses the transmitted GTP-U Error Indication as the new SA communication confirmation response packet.

Also, the encryption processing unit 2 of eNB 10 may transmit, in place of GTP-U Echo Request signal, ICMP Echo signal as the new SA communication confirmation request packet. At this time, the security GW 20 transmits ICMP Echo Reply signal as the new SA communication confirmation response packet to eNB 10.

Further, the encryption processing unit 2 of eNB 10 may transmit some other responsive signal as the new SA communication confirmation request packet to the security GW 20, and receive response packet from the security GW 20 as communication confirmation.

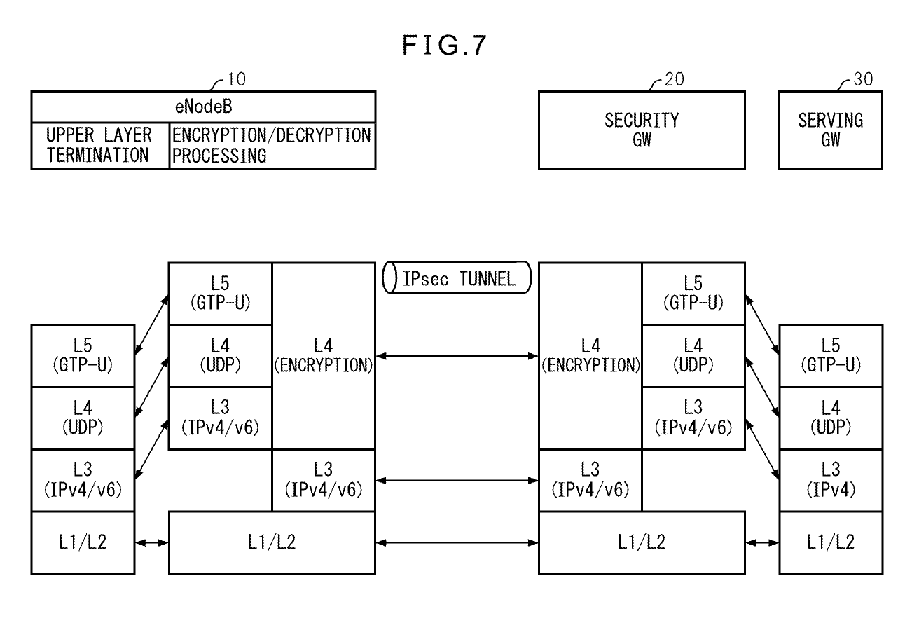

FIG. 7 is a protocol stack depicting layers of network protocols in the case where GTP-U Echo Request/Reply signal is used for new SA communication confirmation in the rekey processing sequence between eNB 10 and the security GW 20 according to the present embodiment. In the example of FIG. 7, in particular, since one of the apparatuses in IPsec communication is the security GW 20, the case where tunnel mode is used is illustrated. In the example of FIG. 7, GTP-U used for the new SA communication confirmation is included in L5.

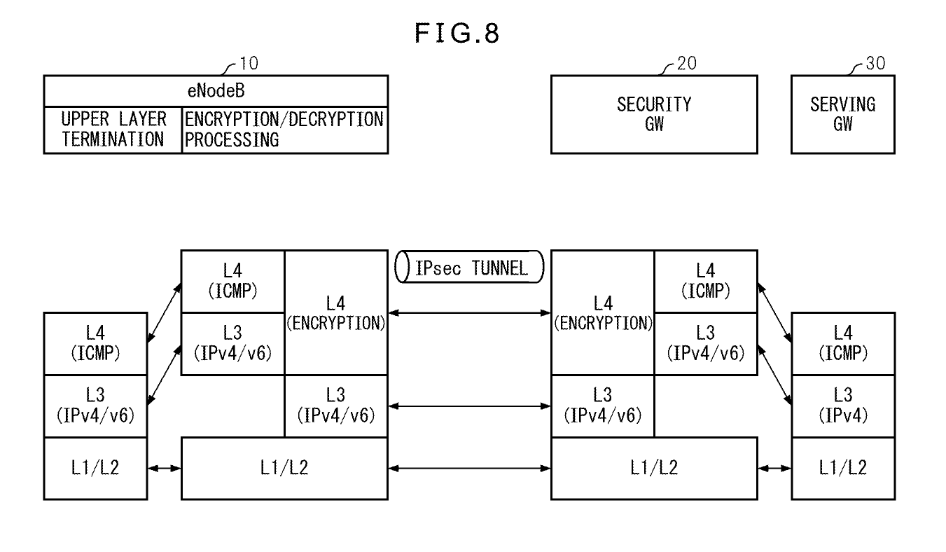

On the other hand, in an aspect where ICMP Echo Request is used for the new SA communication confirmation, ICMP protocol is included in L4 as depicted in FIG. 8.

With the radio base station apparatus of the present embodiment, since eNB 10 uses old SA to transmit a user packet while the security GW is registering new SA, discard of user packets that use new SA can be advantageously suppressed. Thus, retransmission of discarded packets by upper layers can be suitably avoided, and increase of traffic in a network can be suitably suppressed. Also, especially in a LTE system, in order to realize handover between eNBs, the signal between eNB and the serving GW is copied and used between the first eNB and the second eNB for which handover is to be performed. At this time, since copying of signal between the eNBs is done in real time, influence of discard of packets is as close to zero as possible. In accordance with the present embodiment, discard of packets can be appropriately suppressed so that handover in LTE system can be suitably realized.

Although, in the example described above, IPsec communication between eNB and the security GW is illustrated, the present embodiment may be applied to IPsec communication between other apparatuses, or to any other encrypted communication.

### (3) Second Embodiment

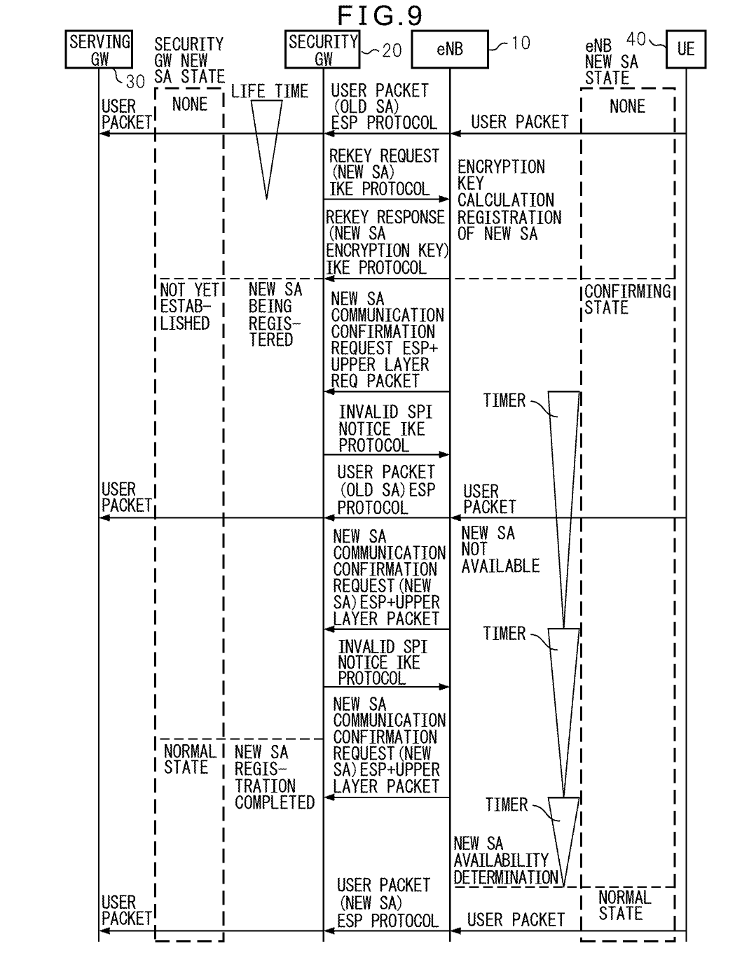

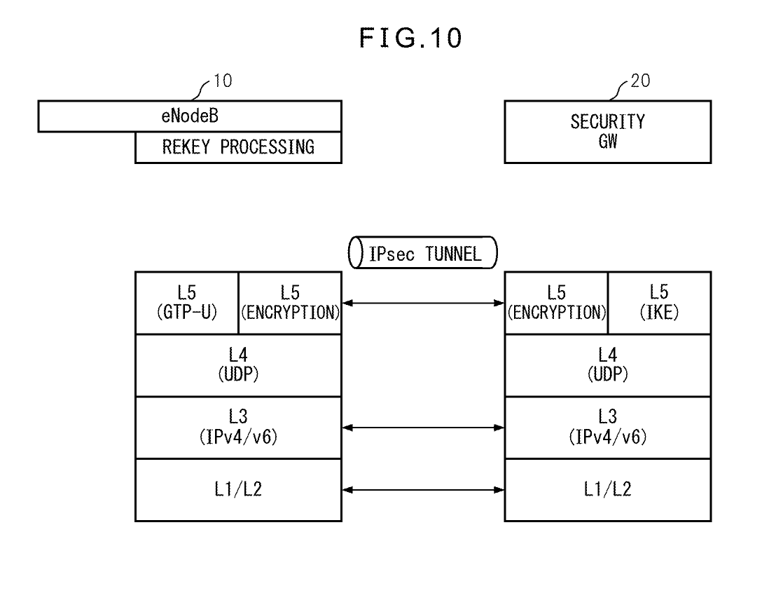

Rekey processing sequence of the encryption key in a communication apparatus according to a second embodiment will be described below with reference to FIGS. 9 and 10. FIG. 9 is a view depicting the processing sequence of each unit in the rekey processing of the encryption key according to the second embodiment, and FIG. 10 is a view depicting the protocol stack in the rekey processing of the encryption key according to the second embodiment.

In the communication system using eNB 10 of the present embodiment, the encryption processing unit 2 of eNB 10 encrypts a user packet transmitted from UE 40 using old SA before updating, and transmits it through ESP protocol to the security GW 20 on the receiving side of IPsec communication. The security GW 20 transmits the received user packet to the serving GW 30 as an opposing apparatus.

Next, if lifetime of the old SA before updating expires, the security GW 20 executes rekey request to eNB 10 using IKE protocol. Upon receiving the rekey request, the rekey processing unit 1 of eNB 10 executes calculation of encryption key and performs registration processing of new SA.

After the rekey processing unit 1 of eNB 10 has completed registration processing of the new SA, the rekey processing unit 1 of eNB 10 transmits new encryption key information using IKE protocol as rekey response to the security GW 20, and switches the state of the new SA to the confirmed state. Upon receiving the transmitted encryption key after updating, the security GW 20 performs registration processing of the new SA. While the registration processing of the new SA is being performed in the security GW 20, the new SA is not yet established in the security GW.

While new SA is being registered in the security GW 20, the encryption processing unit 2 of eNB 10 transmits a user packet to the security GW 20 using old SA before updating. In the security GW while registering new SA, the new SA is not yet enabled and the old SA before updating is enabled. Therefore, communication of user packets using the old SA is possible.

The new SA communication confirmation processing unit 5 of eNB 10 transmits the new SA communication confirmation request to the security GW 20 using the new SA and through ESP protocol and upper layer packet. As described above, the new SA cannot be used in the security GW 20 while registering the new SA, so that it responds with an invalid SPI notice to the rekey processing unit 1 of eNB 10. Invalid SPI notice means “Invalid SPI” notified as IKE message when signal using unreceivable SA is received.

If the new SA communication confirmation processing unit 5 of eNB 10 received invalid SPI notice as a response after it transmits the new SA communication confirmation request, it transmits, after a certain time, the new SA communication confirmation request again to the security GW 20. Also, if further invalid SPI notice is received as a response, the new SA communication confirmation processing unit 5 of eNB 10 transmits, after a further certain time, the new SA communication confirmation request again to the security GW 20. Specifically, the new SA communication confirmation processing unit 5 of eNB 10 comprises an internal timer for the new SA communication confirmation, and if invalid SPI notice is received as a response within a certain period determined by the timer, it transmits the new SA communication confirmation request to the security GW 20.

When a certain time has elapsed after start of registration processing, registration of the new SA is completed and the new SA is enabled. The security GW 20 does not transmit invalid SPI notice to the new SA communication confirmation request received while the new SA is in normal state. Thus, if invalid SPI notice is not received in response within the certain period determined by the timer, the new SA communication confirmation processing unit 5 determines that the new SA can be used in the security GW 20. The transmission period of the new SA communication confirmation request is set sufficiently long as compared to the time from transmission of the communication confirmation request until response of invalid SPI notice. Thereafter, the new SA communication confirmation processing unit 5 switches the state of the new SA to normal state, and the encryption processing unit 2 starts transmission of user packet using the new SA.

FIG. 10 is a view depicting the protocol stack between eNB 10 according to the second embodiment and the security GW 20. In the second embodiment wherein the invalid SPI notice by IKE protocol is used as the new SA communication confirmation, IKE protocol as depicted in FIG. 10 is included in L5.

In accordance with the rekey processing sequence according to the second embodiment, the new SA communication confirmation processing unit 5 of eNB 10 transmits an encrypted packet encrypted using new SA as the new SA communication confirmation request packet to the security GW 20. Thereafter, since invalid SPI notice is not received within certain time, it determines that the new SA is in enabled state in the security GW 20, and switches transmission of user packet from the old SA to the new SA.

Since, in accordance with rekey processing sequence according to the second embodiment, communication confirmation response processing needs not be performed in IPsec opposing apparatus, increase of traffic or processing load can be further suppressed. Also, since the new SA communication confirmation is possible only by the processing on IPsec transmission side irrespective of the state or processing of IPsec opposing apparatus, it is more advantageous for construction of the network.

### (4) Third Embodiment

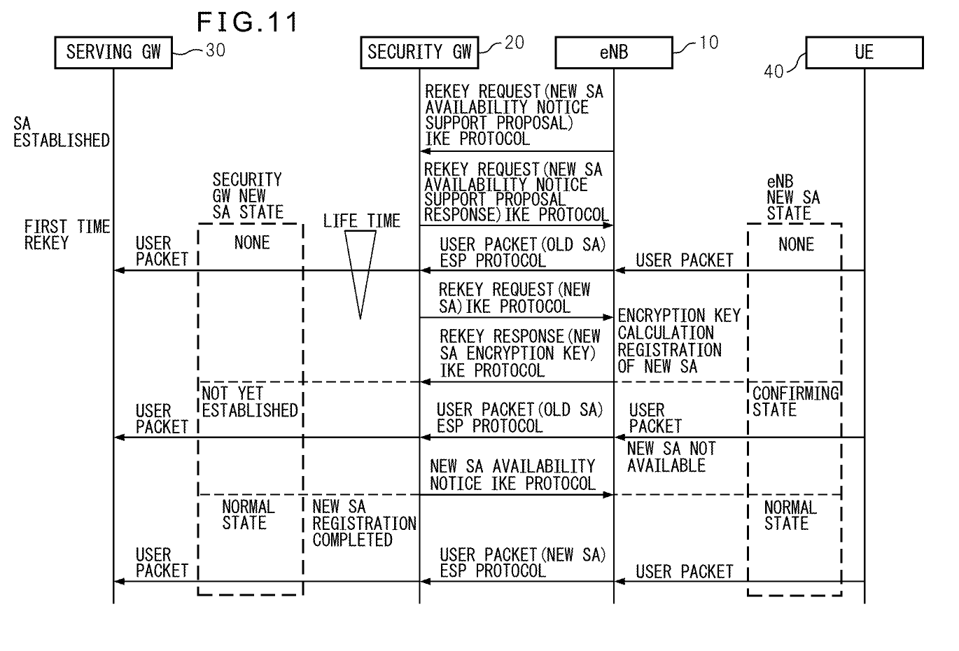

Rekey processing sequence of the encryption key in the communication apparatus according to a third embodiment will be described below with reference to FIG. 11. FIG. 11 is a view depicting processing sequence of each part in the rekey processing of encryption key according to the third embodiment.

In the communication system using eNB 10 of the present embodiment, the new SA communication confirmation processing unit 5 of eNB 10 proposes the new SA availability notice support as an element of the rekey request to the security GW 20 when SA is established. If the security GW 20 has the new SA availability notice support function, the security GW 20 transmits the new SA availability notice support response to eNB 10. Proposal of the new SA availability notice support is done by IKE protocol, and the new SA availability notice support proposal and its response message is included and transmitted, for example, in the proposal payload in the Auth Channel.

The encryption processing unit 2 of eNB 10 encrypts a user packet transmitted from UE 40 using old SA before updating, and transmits it through ESP protocol to the security GW 20 on the receiving side of IPsec communication. The security GW 20 transmits the received user packet to the serving GW 30 as an opposing apparatus.

Next, if lifetime of the old SA before updating expires, the security GW 20 executes rekey request to eNB 10 using IKE protocol. Upon receiving the rekey request, the rekey processing unit 1 of eNB 10 executes calculation of encryption key and performs registration processing of new SA.

After the rekey processing unit 1 of eNB 10 has completed registration processing of the new SA, the rekey processing unit 1 of eNB 10 transmits new encryption key information using IKE protocol as rekey response to the security GW 20, and switches the state of the new SA to the confirmed state. Upon receiving the transmitted encryption key after updating, the security GW 20 performs registration processing of the new SA. While the registration processing of the new SA is being performed in the security GW 20, the new SA is not yet established in the security GW.

While new SA is being registered in the security GW 20, the encryption processing unit 2 of eNB 10 transmits a user packet to the security GW 20 using old SA before updating. In the security GW while registering new SA, the new SA is not yet enabled and the old SA before updating is enabled. Therefore, communication of user packets using the old SA is possible.

When the new SA registration processing is completed in the security GW 20 and the new SA is in normal state, based on the new SA availability notice support proposal, the security GW 20 transmits the new SA availability notice to eNB 10 through IKE packet. Receiving the new SA availability notice, the new SA communication confirmation processing unit 5 of eNB 10 switches the state of the new SA to the normal state, and the encryption processing unit 5 starts transmission of user packets using the new SA.

In accordance with rekey processing sequence according to the third embodiment, the new SA communication confirmation processing unit 5 of eNB 10 proposes transmission of new SA availability notice indicating availability of new SA to the security GW 20. The security GW 20 having the function of new SA availability notice transmits, when the new SA is enabled, an IKE packet of the new SA availability notice to eNB 10. Upon receiving the new SA availability notice, the new SA communication confirmation processing unit 5 of eNB 10 changes the state of the new SA to normal state.

If the security GW 20 has not the function of new SA availability notice transmits, that is, if there is no response to the new SA availability notice support proposal, the new SA communication confirmation processing unit 5 of eNB 10 may perform the processing according to the first embodiment or the second embodiment as described above to confirm whether or not the new SA is in communication.

In accordance with rekey processing sequence according to the third embodiment, availability of the new SA can be confirmed between eNB 10 and the security GW 20, so that timing of availability of the new SA can be suitably shared.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A communication apparatus that performs encrypted communication of data to an opposing apparatus, the communication apparatus comprising:
a communication unit which uses an encryption key to perform encrypted communication of the data;
a rekey unit which updates the encryption key; and
a control unit which, after it is confirmed that communication using the encryption key after updating has been enabled, starts encrypted communication of the data using the encryption key after updating.

2. The communication apparatus according to claim 1, wherein the control unit transmits signal requesting confirmation that communication using the encryption key after updating has been enabled to the opposing apparatus, and in accordance with the response from the opposing apparatus, confirms whether or not communication using the encryption key after updating has been enabled.

3. The communication apparatus according to claim 1, wherein the control unit determines the next timing for confirming whether or not communication using the encryption key after updating has been enabled, based on a period from updating of the encryption key until confirmation that communication using the encryption key after updating has been enabled.

4. The communication apparatus according to claim 1, wherein the control unit determines the next timing for starting communication using the encryption key after updating, based on a period from updating of the encryption key until confirmation that communication using the encryption key after updating has been enabled.

5. The communication apparatus according to claim 1, wherein the control unit transmits the data using the encryption key after updating to the opposing apparatus, and confirms whether or not communication using the encryption key after updating has been enabled, based on invalidity notice transmitted from the opposing apparatus.

6. The communication apparatus according to claim 1, wherein the control unit transmits signal requesting notice of availability of the encryption key after updating to the opposing apparatus after communication using the encryption key after updating has been enabled in the opposing apparatus.

7. The communication apparatus according to claim 1, wherein, after rekey request of the encryption key is received from the opposing apparatus, the control unit confirms whether or not communication using the encryption key after updating is enabled based on communication using the encryption key after updating.

8. A communication method in a communication apparatus that performs encrypted communication of data to an opposing apparatus, the communication method comprising:
performing encrypted communication of the data using an encryption key;
updating the encryption key; and
starting encrypted communication of the data using the encryption key after updating controlling, after it is confirmed that communication using the encryption key after updating has been enabled.

9. A communication system which performs encrypted communication of data between a communication apparatus and an opposing apparatus, wherein at least one of the communication apparatus and the opposing apparatus comprises:
a communication unit which uses an encryption key to perform encrypted communication of the data;
a rekey unit which updates the encryption key; and
a control unit which, after it is confirmed that communication using the encryption key after updating has been enabled, starts encrypted communication of the data using the encryption key after updating.
